(19) United States
(12) Patent Application Publication
(10) Pub. No.: US 2003/0195796 A1
(43) Pub. Date: Oct. 16, 2003

(54) Internet activity rating system

(76) Inventors: Vijay Konda, Sharon, MA (US); Chandana Divi, Quincy, MA (US)

Correspondence Address: REINHART BOERNER VAN DEUREN S.C., ATTN: LINDA GABRIEL, DOCKET COORDINATOR, 1000 NORTH WATER STREET, SUITE 2100, MILWAUKEE, WI, 53202, US

(21) Appl. No.: 10/431,062

(22) Filed: May 7, 2003

Related U.S. Application Data
(63) Continuation of application No. 09/517,763, filed on Mar. 4, 2000, now abandoned.
(60) Provisional application No. 60/122,777, filed on Mar. 4, 1999.

(51) Int. Cl. G06F 17/60

(52) U.S. Cl. 705/10

(57) ABSTRACT

The Internet Activity Rating System provides a system that allows for collection, representation, analysis, rating and the distribution of the Internet user's activity information. As the user browses the Internet, by selecting the Uniform Resource Locator (URL), and interacts with the commercial and the non-commercial sites, the user activity is sent to the Internet Activity Persistence Broker, which stores it in the Internet Activity Information Domain. The format of the activity persistent storage is defined by the Internet Activity Format definition. The main purpose of the Internet Activity Format is the aggregation and the rating of the Internet activity information. The Internet Activity Information Domain makes the activity information and its rating available to other Internet sites that request the information as well as to individuals who wish to verify and perhaps modify their activities. This information is available in the form of the Internet Activity Reports as well as in the form of the Internet Activity Rating.

This application is a continuing application of application Ser. No. 09/517,763, filed Mar. 4, 2000, which claims priority from Provisional Application No. 60/122,777, filed Mar. 4, 1999.

### BACKGROUND OF THE INVENTION

1. Field of Invention

This invention generally relates to the field of Internet. More specifically, the invention concerns the collection, use and distribution of the Internet Activity Information.

2. Description of the Prior Art

The Internet has become a dominant force in the modem times to provide services, such as information retrieval and commerce. One of the most fundamental functionality of Internet services is their ability to customize the services based on the user's activity history. At the present time. Internet services collect activity information exclusively within their own sites. Internet services have no mechanism to access the information in the context of the entire Internet. The Internet Activity Rating is all but non-existent, despite the fact that it is a fundamental concept to the process of the service customization and user verification.

### SUMMARY OF THE INVENTION

It is an object of the present invention to provide an Internet Activity Rating System used by Internet sites to customize their presentations.

It is another object of the present invention to obtain a persistence history of the user.

The present invention defines the architectural elements of the system and the cooperation among them in order to achieve the above objects and others. One of the fundamental functions of the Internet Activity Rating System is its persistence of the history of User activities on the Internet. These activities are represented by the Uniform Resource Locators (URLs) selected during the user's interaction process with the Internet and are sent to the Internet Activity Persistence Broker. Every Internet user is represented by a collection of his/her activities performed over a period of time. The primary purpose of the Internet Activity Persistence Broker is the storage of user activities in the Internet Activity Information Domain, using the format described by the Internet Activity Format. The format emphasizes an aggregation and rating of the activity information. The aggregation process of the activity information is based on the activity subjects. The independent activity rating mechanism is a formula applied to the activity aggregates, which results in a user activity rating number. The activity information is available to the Internet Activity Rating System customers in the form of Internet Activity Reports and the Internet Activity Ratings. Most Internet sites need to customize their content presentation, based on the user's preferences. These sites or entities can obtain the public activity information from the Internet Activity Rating System and customize their content display to accommodate user's interests. The activity information is also available to its owner through the Internet Activity Viewer Broker. The Internet Activity Rating System allows the owner of the activity information to have a direct control over the content of his/her activity information. For example, the owner is allowed to define the types of activities to be rated. The owner can also determine who has access to its activity information.

### BRIEF DESCRIPTION OF THE DRAWINGS

These and other advantages of the present invention are better understood by reading the following detailed description of the preferred embodiment, taken in conjunction with the accompanying drawings, in which:

FIG. 1 illustrates the Internet Activity Rating System, which employs the principles of the present invention.

FIG. 2 illustrates the present invention from the user perspective.

### DETAILED DESCRIPTION OF THE PREFERRED EMBODIMENT

The following detailed description begins with the architecture overview of the Internet Activity Rating System and continues with a detailed description of the system.

Architecture

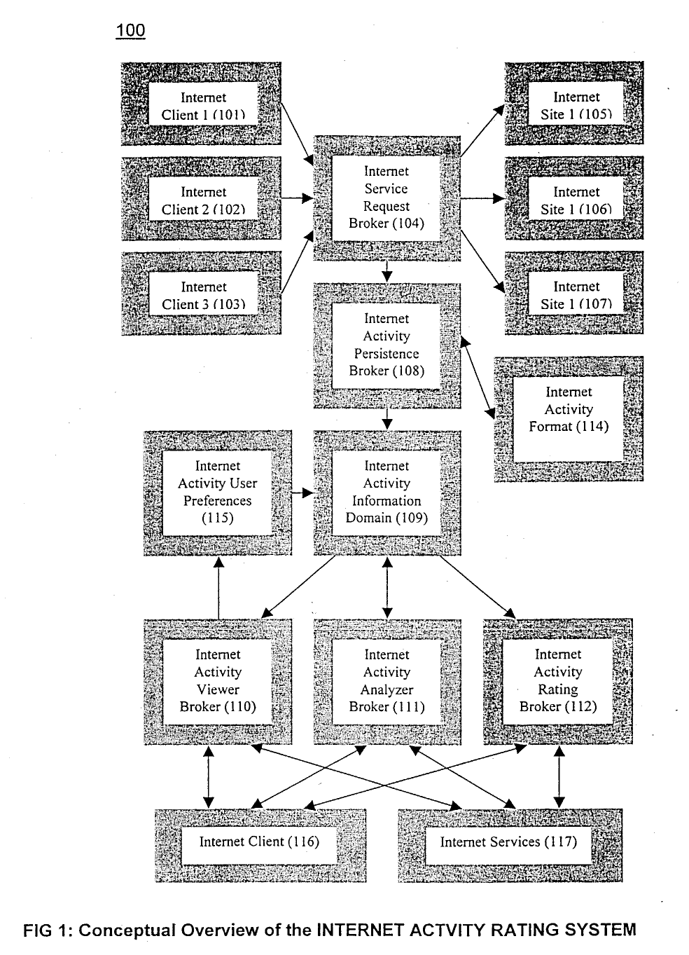

FIG. 1 presents an overview of the Internet Activity Rating System, which incorporates the field of invention. A preferred embodiment of the Internet Activity Rating System is implemented using digital computer system and information sources, which are accessible via the Internet network.

The Internet Activity Rating System is composed of five elements; The Internet Activity Persistence Broker 108, the Internet Activity Viewer Broker 110, the Internet Activity Analysis Broker 110, the Internet Activity Rating Broker 111, and the Internet Activity Information Domain 109.

Internet activities between the Internet clients and the Internet sites are monitored by the Internet Service Request Broker 104 and are sent to the Internet Activity Persistence Broker 108. On receiving a new Internet activity information, the Internet Activity Persistence Broker 108 communicates with the Internet Activity Information Domain 109, which maintains the activity information about the Internet users. Internet Activity Information Domain 109 uses the Internet Activity Format 114, which defines the format of the activity information. The format aggregates the activity information based on the Internet user identification information and based on the activity subjects.

The Internet activity information can be accessed by either Internet services or by Internet users. The Internet Activity Viewer Broker 110 is used to generate reports on the Internet user activity from the Internet Activity Information Domain 109. The Internet services can request the Internet Activity Viewer Broker 110 for user activity information, such as who uses the services or what service elements are used most frequently. Internet users can view reports about their activities and can also review their private information distribution reports, such as the list of services, which requested and received the user's private information. The Internet Activity Viewer Broker 110 generates the activity reports based on the activity information received from the Internet Activity Information Domain 109.

Internet services and Internet users can also request the Internet Activity Analysis Broker 111 for analytical information regarding the Internet user activities. The activity analysis includes information, such as the ratio of specific type of activities to the total number of activities. For example, the analysis information includes the ratio of number of purchases made versus the number of times of page views. The Internet Activity Analyzer Broker 111 generates the activity analysis reports based on the activity information received from the Internet Activity Information Domain 109.

The Internet Activity Rating Broker 112 is used by the Internet services to obtain the user activity rating information. The Internet Activity Rating Broker 112 applies certain activity rating formulas to the user activity information received from the Internet Activity Information Domain 109, based on the type of activity to arrive at the user activity rating for that particular type of activity. This results in a rating value, which defines the rating of the specific user for that particular type of activity.

The Internet user activity reports, requested by the Internet services are generated based on the user's Internet user's activity preference. The preference defines which activities are public. Only public activities can be included into the activity reports and the activity ratings.

Internet Activity Persistence Broker 108

Internet activities between the Internet clients and the Internet sites are monitored by the Internet Service Request Broker 104 and are sent to the Internet Activity Persistence Broker 108. The Internet Activity Persistence Broker 108 stores the Internet user activities in the Internet Activity Information Domain 109 using the Internet Activity Format 114, which defines the format of the activity information.

Internet Activity Information Domain 109

The Internet Activity Information Domain 109 is a storage mechanism used to manage a persistent representation of the user activity information. The layout of the persistent representation of the activity information is defined by the Internet Activity Format 114. The format defines the aggregation of the activity information based on the Internet user identification information and based on the activity subjects.

Activity Definition GUI 118

The Activity Definition GUI 118 provides user interface for Administrator 119 of the Internet Activity Rating System 100 to define what is activity at each Internet site. For example at a site ‘Amazon.com’ if the user clicks at URL representing a book, then it can be defined as a ‘Browse Books’ activity and if the user clicks on a URL representing the purchase of a book, then it is defined as a ‘Purchase Books’ activity. The Definition GUI 118 also lets the Administrators define the activity rating formulas like ‘Browse Books vs. Purchase Books’. This definition of the Rating formulas will enable the system to add a flexible new Activity Ratings to be included into the System.

Internet Activity Viewer Broker 110

The Internet Activity Viewer Broker 110 is used to generate reports on the Internet user activity from the Internet Activity Information Domain 109. The Internet Activity Viewer Broker 110 generates the Internet activity information reports for both the Internet services and the Internet users.

Internet Activity Analyzer Broker 111

The Internet Activity Analyzer Broker ill defines the Internet activity analysis functionality. The broker 111 generates analysis reports based on the Internet user activity from the Internet Activity Information Domain 109. These analysis reports are available to Internet services and Internet users.

Internet Activity Rating Broker 112

The Internet Activity Rating Broker 112 is used by the Internet services to obtain the user activity rating information. The Internet Activity Rating Broker 112 applies activity rating formulas defined using the Activity Definition GUI 118 on the user activity information received from the Internet Activity Information Domain 109. This results in a rating value, which defines the rating of the specific user for that particular type of activity.

Internet Activity Format 114

The Internet Activity Format 114 defines a layout for the Internet user activity information, which is stored by the Internet Activity Information Domain 109. The format aggregates the activity information based on the Internet user identification information and based on the activity subjects.

Internet Activity User Preferences 115

The Internet Activity Rating System allows the owner of the activity information to have a direct control over the content of its activity information. For example, the owner is allowed to define types of activities to be rated. The owner can also determine who has access to his/her activity information. The preference information is represented by the Internet Activity User Preferences 115.

Execution

Internet activities between the Internet clients and the Internet sites are monitored by the Internet Service Request Broker and are sent to the Internet Activity Persistence Broker, which stores them in the Internet Activity Information Domain. The Internet Activity Rating System applies ratings formulas to the Internet user activity information to arrive at an Internet rating system for Internet users for each type of activity. The persistent layout of the Internet activity information is defined by the Internet activity format definition. The format aggregates the activity information based on the Internet user identification and based on the activity types. Different rating formulas are applied to the selected segments of the user activity information to generate the Internet Activity Ratings for the specific users for particular types of activities.

The detailed description has disclosed implementation details of the Internet Activity Rating System that acts as an activity rating service to the entire Internet community. The activity rating information is fundamental to the functioning of the Internet commerce. It translates an abstract concept of the Internet user activity into a precise representation easily understood and manipulated by the Internet community.

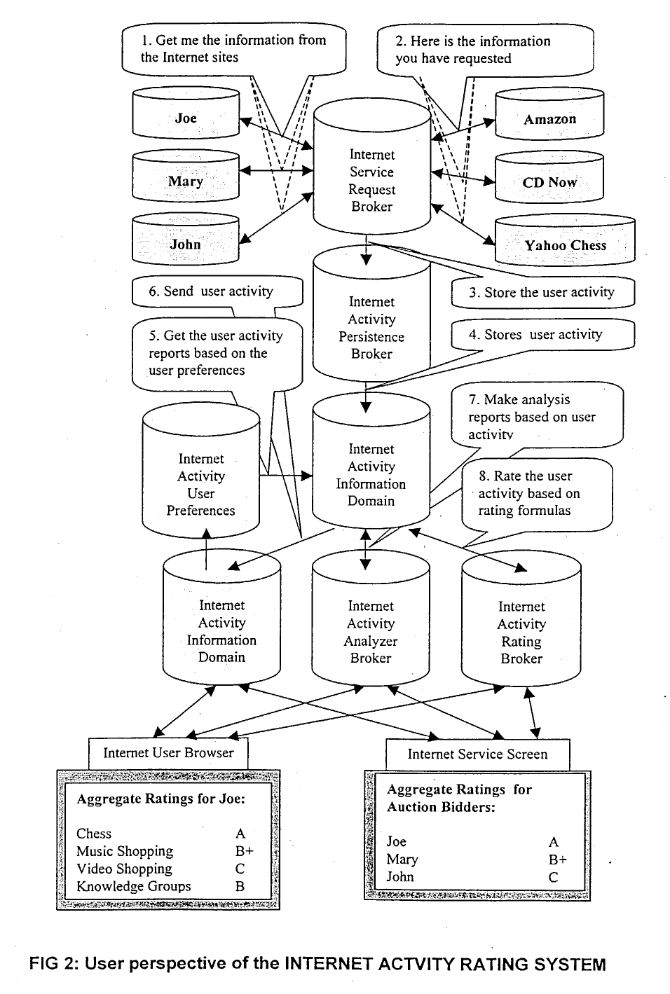

FIG. 2 shows the interaction between the Internet Activity Rating System and its users as described by the following steps:

1. An Internet user requests for information by selecting a Uniform Resource Locator (URL).

2. The Internet Service Request Broker sends the request to the destination site and to the Internet Activity Persistence Broker.

3. The Internet Activity Persistence Broker stores the information in the Internet Activity Information Domain.

4. An Internet service requests the Internet Activity Viewer Broker for the Internet Activity Reports regarding specific Internet users, specific Internet activities or any combination of the user and activity information.

5. An Internet user requests the Internet Activity Viewer Broker for the Internet Activity Reports regarding its Internet activities.

6. The Internet Activity Viewer Broker generates activity reports based on the activity information.

7. An Internet service requests the Internet Activity Analyzer Broker for the analysis of the Internet activity information regarding specific Internet users, specific Internet activities or any combination of the user and activity information.

8. An Internet user requests the Internet Activity Analyzer Broker for the analysis of its Internet activity information.

9. The Internet Activity Analyzer Broker generates analysis reports based on the activity information.

10. An Internet service requests the Internet Activity Rating Broker for the rating information regarding specific Internet users, specific Internet activities or any combination of the user and activity information.

11. An Internet user requests the Internet Activity Rating Broker for the rating information regarding its Internet activities.

12. The Internet Activity Rating Broker calculates the Internet Activity Rating value by applying the rating equation to the activity information.

13. An Internet user defines its Internet Activity User Preferences by setting privacy characteristic of its Internet activity types.

While the invention has been described in connection with what is presently considered to be the preferred embodiments, it is understood that the invention is not limited to the disclosed embodiments. For example, each of the features described above can be used singly or in combination, as set forth below in the claims, without other features described above which are patentably significant by themselves. Accordingly, the present invention is intended to cover various modifications and equivalent arrangements included within the spirit and scope of the appended claims.

What is claimed is:

1. A method of monitoring Internet activity comprising the steps of:
determining a predetermined plurality of types of activities to be rated;
associating user actions that take place with said predetermined types of activities;
tracking a sequence of activities of a user, including a sequence of activities within a particular web site; and
obtaining rating information for each of the predetermined types of activities according to the tracked sequence of activities of the user.

2. A method according to claim 1 wherein rating information is used to generate a report based on that information.

3. A method according to claim 2 wherein the report is provided to the user.

4. A method according to claim 1 wherein the user allows other entities to obtain that users rating information.

5. A method according to claim 4 wherein the users rating information obtained by the other entities is only certain information as specified by the user.

6. A method according to claim 1 wherein rating information from a plurality of users is used to generate at least one report.

7. A method according to claim 6 wherein the at least one report is provided to other entities.

8. A method according to claim 1 wherein other entities that obtain rating information on users must supply rating information from their own website.

9. A method according to claim 1 further including the step of customizing functions based upon the rating information.

10. A method according to claim 9 wherein entities customize functions of their websites based on the rating information.

11. A method according to claim 9 wherein the user customizes personal functions based on the users rating information.

12. A method according to claim 1 wherein the rating information can be obtained in real time.

13. A method according to claim 1 wherein the rating information is only obtained from certain sites.

14. A method according to claim 1 wherein the types of activities to be rated includes browsing for a purchase and making a purchase.
